(19) United States
(12) Patent Application Publication
(10) Pub. No.: US 2015/0033756 A1
(43) Pub. Date: Feb. 5, 2015

(54) Gas Turbine with Primary and Secondary Lubricating Oil Cooler

(71) Applicant: Nuovo Pignone S.r.l., Firenze (IT)

(72) Inventors: Marco Lazzeri, Florence (IT); Simone Bei, Florence (IT); Filippo Viti, Florence (IT); Roberto Merlo, Florence (IT); Daniele Marcucci, Florence (IT)

(21) Appl. No.: 14/383,861

(22) PCT Filed: Mar. 6, 2013
(86) PCT No.: PCT/EP13/54528

§ 371 Date: Sep. 8, 2014

(30) Foreign Application Priority Data
Mar. 8, 2012 (IT) FI2012A000047

(51) Int. Cl. F01D 25/12; F01D 25/20; F02C 7/12

(52) U.S. Cl. CPC F01D 25/125; F02C 7/12; F01D 25/20
USPC 60/782; 60/785; 60/39.08

(57) ABSTRACT

A gas turbine including: a turbine package, a gas turbine, a ventilation system for cooling the interior of the turbine package, and a lubricating oil circuit. The lubricating oil circuit comprises a lubricating oil pump, a lubricating oil tank, a primary lubricating oil cooler, and a secondary lubricating oil cooler. The secondary lubricating oil cooler is arranged in the turbine package, in a position lower than a rotary shaft of the gas turbine. The ventilation system is arranged and designed such that at least part of a package cooling airflow contacts the secondary lubricating oil cooler to remove heat from the lubricating oil circulating in the secondary lubricating oil cooler.

### FIELD OF THE INVENTION

Embodiments of the present disclosure relate to gas turbines, particularly aeroderivative gas turbines. More specifically, embodiments of the present disclosure relate to improvements in the lubricating oil circuit and lubricating-oil heat exchangers for gas turbines.

### DESCRIPTION OF THE RELATED ART

Lubricating oil, or lube oil, is specifically used in gas turbines to lubricate and cool bearings, which support the rotary shafts of the gas turbine. A gas turbine may include one or more rotary shafts, depending upon the structure and design of the gas turbine.

In some known gas turbines the lubricating oil is also used to vary the geometry of the stationary or rotary vanes and blades of the gas turbine, e.g. to adapt the geometry to specific operating conditions. The lubricating oil circuit will in this case provide not only the lubricating oil to the bearings, but also to a hydraulic system comprising hydraulic actuators for controlling the geometry of the turbomachine.

This results in a large amount of heat being transferred to the lubricating oil. It becomes necessary removing heat from the lubricating oil, in order to maintain the lubricating oil and therefore the mechanical components, through which the lubricating oil circulates, at acceptable temperatures.

FIG. 1 shows schematically a gas turbine with a lubricating oil circulating system. The gas turbine is indicated with reference number 1 as a whole. In the embodiment shown in FIG. 1, the gas turbine comprises a compressor 3, a high pressure turbine 5, a power turbine 7, also named low pressure turbine, and a combustor 9. The gas turbine is housed in a turbine package, not shown in the schematic of FIG. 1. The rotor of compressor 3 and the rotor of the high pressure turbine 5 are torsionally connected to a common shaft 11. The common shaft 11 is supported by bearings 13 and 15 in the machine casing. The compressor 3 and the high pressure turbine 5 rotate at the same rotary speed. The rotor of the power turbine 7 is torsionally connected to a rotary shaft 17, which is supported by bearings 19 and 21 in the machine casing.

The air compressed by the compressor 3 enters the combustor 9, where the compressed air is mixed with a gaseous or liquid fuel. The fuel is ignited and high pressure, high temperature, combustion gases are produced. The combustion gases are expanded in the high pressure turbine 5 to generate power for driving the compressor 3 through shaft 11. The partially expanded combustion gases are then further expanded in the power turbine 7. The power generated by further expansion in the power turbine is used to drive a load, for example a compressor or compressor train, an electric generator, or the like. In the schematic representation of FIG. 1 the load is generically labeled 23.

Lubricating oil is circulated through the bearings 13, 15, 19 and 21 to lubricate the bearings and remove heat therefrom. A lubricating oil circuit 23 is provided for that purpose. The lubricating oil circuit comprises a lubricating oil tank 25, from which the lubricating oil is aspirated through a lubricating oil pump 27, which feeds the lubricating oil through a lubricating oil pipe 29. The lubricating oil is then distributed to the bearings of the gas turbine 1. The lubricating oil from the bearings 13, 15, 19 and 21 is collected in a collecting duct 31 and is returned to the lubricating oil tank 25 through a scavenger pump 33, downstream whereof a check valve 35 is provided. The scavenger pump 33 maintains the bearings 13, 15, 19 and 21 under slight under-pressure to avoid lubricating oil escaping the bearings and flooding the gas turbine 1. Between the scavenger pump 33 and the lubricating oil tank 25 a primary lubricating oil cooler 37 is provided, through which the lubricating oil flows and heat is removed therefrom before returning to the lubricating oil tank 25. The primary lubricating oil cooler 37 can comprise an oil/air heat exchanger. Reference number 39 schematically indicates a blower, which generates an airflow for removing heat from the lubricating oil flowing through the primary lubricating oil cooler 37. The primary lubricating oil cooler 37 can also be an oil/water heat exchanger, rather than an oil/air heat exchanger.

In some known gas turbines, the gas turbine comprises a variable-geometry hydraulic system 40. This system uses the lubricating oil circulating in the lubricating oil circuit 23 to drive the movement of movable blades of the gas turbine 1, in order to adapt the geometry of the gas turbine to the operating conditions. A high-pressure lubricating oil pump 41 is provided to increase the pressure of the lubricating oil and to feed the pressurized lubricating oil to the actuators of the variable-geometry hydraulic system 40. The lubricating oil returning from the variable-geometry hydraulic system 40 into the lubricating oil pipe 29 has been heated up and the temperature thereof has increased. In some situations, a secondary lubricating oil cooler 43 becomes necessary, to remove the excess heat transferred to the lubricating oil when circulating in the variable-geometry hydraulic system 40. This secondary lubricating oil cooler 43 can be an oil/air or an oil/water heat exchanger, for example.

When the gas turbine 1 is shut-down, the scavenger pump 33 is stopped and flow of the lubricating oil from the collecting duct 31 towards the lubricating oil tank 25 is prevented. This can cause flooding of the bearings of the turbomachinery.

### SUMMARY OF THE INVENTION

According to some embodiments, the secondary lubricating oil cooler is arranged inside the turbine package. The secondary lubricating oil cooler is arranged within the turbine package so that a portion of a cooling airflow circulating in the turbine package and provided for cooling the gas turbine casing flows through the secondary lubricating oil cooler and removes heat therefrom. The secondary lubricating oil cooler is arranged in a position such that flooding of the gas turbine is prevented in case of shut-down. This is, for example, achieved by arranging the secondary lubricating oil cooler in a position below the axis of rotation of the gas turbine, i.e. below the gas turbine shaft. In this context, should the gas turbine have more than one shaft, for example two or more coaxial shafts arranged one within the other, as commonly provided for in double-shaft or multiple-shaft aeroderivative gas turbines, the definition “below the gas turbine shaft” should be understood as indicating a location or position below the combination of one or more shafts of the gas turbine. More specifically, below the gas turbine shaft means in a position lower than the shaft(s) and relevant bearings.

In some embodiments a gas turbine is provided, comprising a turbine package, wherein at least one compressor, one high pressure turbine and one power turbine are arranged. The gas turbine may further comprise a ventilation system for cooling the interior of said turbine package. A lubricating oil circuit may further be provided, which can comprise at least: a lubricating oil pump, a lubricating oil tank, a primary lubricating oil cooler. In addition to the primary lubricating oil cooler, the lubricating oil circuit further comprises a secondary lubricating oil cooler. The secondary lubricating oil cooler is arranged in the turbine package, in a position lower than the rotary shaft or shafts of said gas turbine. The ventilation system is arranged and designed, so that at least part of a package-cooling airflow contacts said secondary lubricating oil cooler for removing heat from the lubricating oil circulating in said secondary lubricating oil cooler.

In some embodiments, the lubricating oil circuit comprises a scavenger pump arranged between a lubrication oil sump of the gas turbine sump or any other suitable collecting arrangement for collecting said lubricating oil, and said primary lubricating oil cooler. Between the scavenger pump and the primary lubricating oil cooler additional components can be provided. For example, a non-return valve, i.e. a check valve, can be arranged between the scavenger pump and the primary lubricating oil cooler. In some embodiments, the primary lubricating oil cooler is arranged upstream of the lubricating oil tank. However, in other embodiments, the primary lubricating oil cooler can be positioned downstream of the lubricating oil tank. In such arrangement, the lubricating oil tank would be arranged between the scavenger pump and the primary lubricating oil cooler.

In some embodiments, a combustion-air intake plenum in fluid communication with the compressor or compressors of the gas turbine can be provided. The combustion-air intake plenum is arranged in the turbine package, between a main package compartment, where the gas turbine is arranged, and a cooling air intake compartment. Lateral airflow passages may be formed between side walls of the turbine package and the combustion-air intake plenum. In some embodiments, at least one bottom airflow passage is formed between the combustion-air intake plenum and a bottom wall of said turbine package. Additionally, in some embodiments, the secondary lubricating oil cooler is arranged across an airflow channeling, in fluid communication with the bottom airflow passage extending underneath the combustion-air intake plenum.

In some embodiments, the secondary lubricating oil cooler is arranged underneath an air-pervious bottom panel of a cooling air inlet compartment.

The secondary lubricating oil cooler has a lubricating oil outlet which is, directly or indirectly, in fluid communication with bearings of said gas turbine.

In some exemplary embodiments, the gas turbine includes a variable-geometry hydraulic system forming part of the lubricating oil circuit.

According to a further aspect, the present disclosure also concerns a method of operating a gas turbine comprising the steps of: providing a turbine package and a gas turbine arranged in said turbine package; generating a package-cooling airflow; separating a portion of said package-cooling airflow and circulating said portion of said package-cooling airflow through a secondary lubricating oil cooler, arranged within the turbine package, thus removing heat from lubricating oil circulating in said secondary lubricating oil cooler; and circulating said package-cooling airflow through said turbine package to remove heat from the gas turbine casing.

In addition to the secondary lubricating oil cooler, also the flow connection between the secondary lubricating oil cooler and the bearings of the gas turbine are arranged within the turbine package, making the design more compact and more reliable by preventing dispersion of lubricating oil from the lubricating oil circuit in the environment.

The arrangement of the secondary lubricating oil cooler under the position of the axis of the gas turbine prevents flooding of the machine in case of shut-down and stoppage of the scavenger pump. The scavenger pump will obstruct the flow of lubricating oil towards the lubricating oil tank. However, since the secondary lubricating oil cooler is in a position lower than the bearings, which are located around the axis of the gas turbine, the lubricating oil contained in the secondary lubricating oil cooler will not flood the bearings and the turbomachine.

Features and embodiments of the subject matter are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 schematically illustrates a gas turbine and lubricating oil circuit according to the state of the art;

FIG. 2 illustrates a side view of a gas turbine package according to an embodiment of the invention;

FIG. 3 illustrates a schematic diagram of a gas turbine according to an embodiment of the subject matter disclosed herein;

FIG. 4 illustrates a perspective and partial sectional view of a gas turbine package and relevant turbomachinery housed therein according to an embodiment of the invention; and

FIG. 5 illustrates a schematic of the hydraulic circuit of the lubricating oil according to an embodiment of the present disclosure.

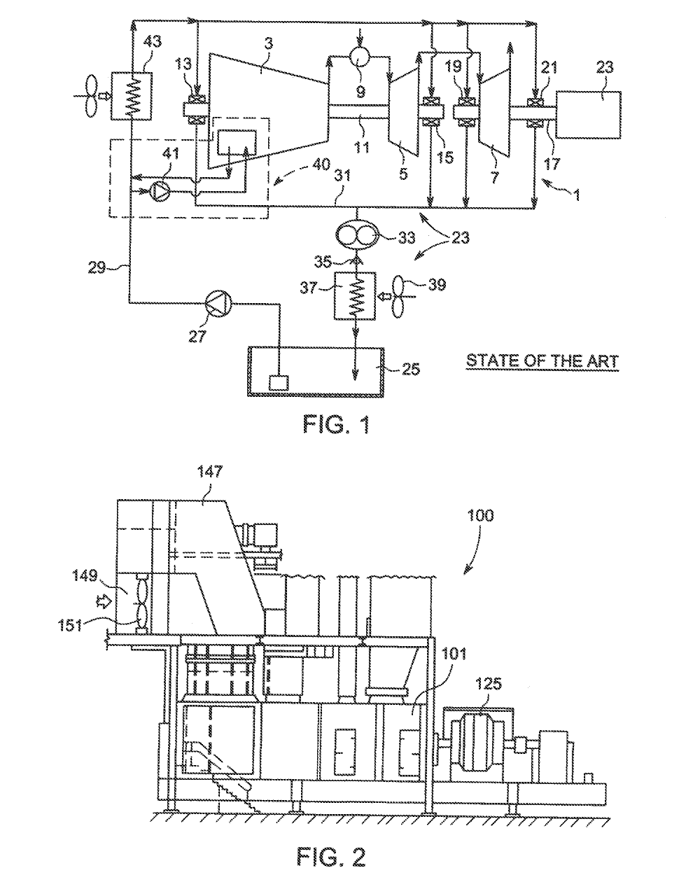

### DETAILED DESCRIPTION OF EMBODIMENTS OF THE INVENTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

In the enclosed drawings, the package layout of a gas turbine is labelled 100 as a whole. The layout includes a gas turbine package 101, below named also simply package or turbine package, in which a gas turbine 103 is housed. In some embodiments, the gas turbine 103 can be a dual-shaft aeroderivative gas turbine, such as, for example, an LM6000 aeroderivative gas turbine, commercially available from GE Aviation, Evendale, Ohio, USA. Other aeroderivative gas turbines can be used.

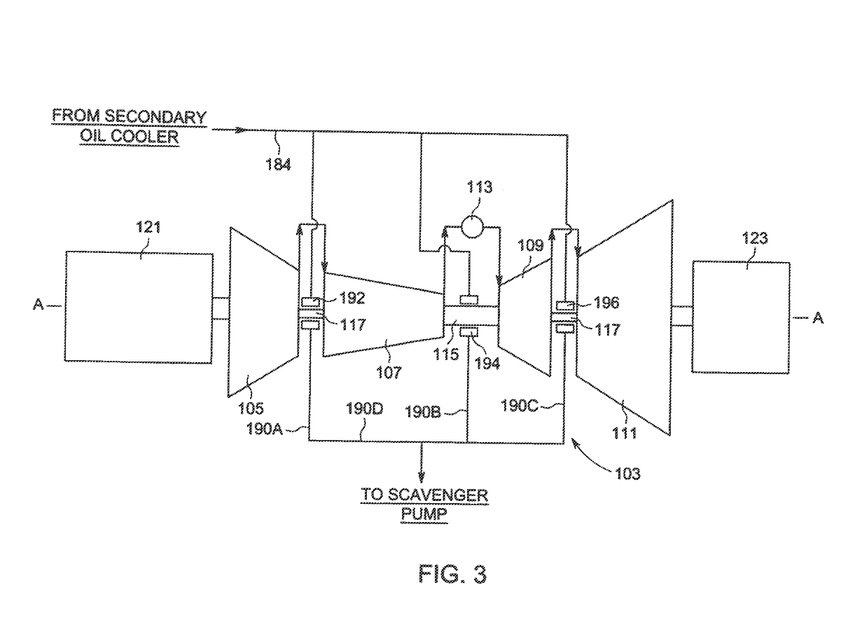

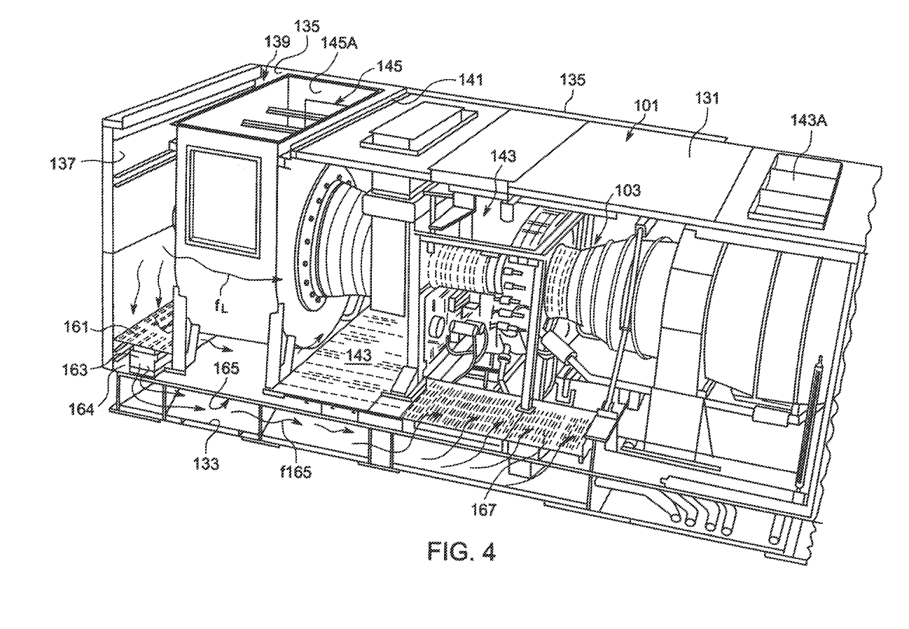

The structure of the gas turbine 103 is illustrated schematically in FIG. 3. The gas turbine 103 comprises a low pressure compressor 105, a high pressure compressor 107, a high pressure turbine 109 and a power turbine, i.e. a low pressure turbine 111. Ambient air is compressed at a first pressure value by low pressure compressor 105 and further compressed by the high pressure compressor 107. The compressed air is mixed with fuel and the air-fuel mixture is burned in a combustor 113 for generating high pressure, high temperature combustion gases, which are expanded sequentially in the high pressure turbine 109 and in the power turbine 111. A first shaft 115 supports the rotor of the high pressure compressor 107 and the rotor of the high pressure turbine 109. A second shaft 117 extends coaxially to the first shaft 115. The second shaft 117 connects mechanically the rotor of the low pressure compressor 105 and the rotor of the power turbine 111.

The cold end drive and the hot end drive of the gas turbine 103 are represented schematically by 121 and 123, respectively. A load can be connected to either the cold end drive 121 or to the hot end drive 123 or both. In the exemplary embodiment of FIG. 2, a load 125 is connected to the hot end drive of the gas turbine 103.

The gas turbine 103 is housed in the package 101, as shown in FIG. 4. The package 101 may include a top wall 131, a bottom wall 133, side walls 135 and end walls 137.

In some embodiments, the turbine package 101 comprises a first compartment 139, and a second compartment 143, wherein the actual gas turbine 103 is housed. The second compartment 143 is provided with an air escape aperture 143A from which the cooling air exits the turbine package 101.

In the first compartment 139, a combustion-air intake plenum 145 is arranged. The combustion-air intake plenum 145 comprises an inlet aperture 145A in fluid communication with an air intake line 147 (FIG. 2). Air is aspirated through the air intake line 147 by the suction effect of the serially arranged low pressure compressor 105 and high pressure compressor 107.

The first compartment 139 forms part of a ventilation system for the circulation of cooling air in the second compartment 143, where the gas turbine 103 is housed. The first compartment 139 is in fluid communication with a cooling air intake line 149, in which a blower 151 can be arranged. Air entering the cooling air intake line 149 circulates through the first compartment 139 and enters the second compartment 143 partly escaping along lateral airflow passages represented by arrows fL and formed between the side walls 135 of the turbine package 101 and the combustion-air intake plenum 145. A fraction or portion of the air entering the cooling air intake line 149 flows through a bottom panel 161 provided in an airflow channelling located in the lower part of the first compartment 139. The bottom panel 161 is arranged in a position below the position of the rotary axis A-A of the gas turbine 103, and therefore in a position lower than the shafts 115 and 117 of the gas turbine 103 and the relevant bearings.

In some embodiments, the bottom panel 161 can be formed as a grid, or as a solid panel provided with apertures, or the like. Cooling air is allowed to flow through the bottom panel 161 and through a secondary lubricating oil cooler 163 arranged underneath the bottom panel 161 across an airflow channelling 164, which establishes a flow connection between the first compartment 139 and a bottom airflow passage 165 extending at least partly underneath the second compartment 143. The cooling air flowing through the secondary lubricating oil cooler 163 removes heat from the lubricating oil circulating in the secondary lubricating oil cooler and further flows through the bottom airflow passage 165 (see arrows f165) towards and into the second compartment 143 of the turbine package 101, wherein the gas turbine 103 is arranged. In some embodiments, the bottom airflow passage 165 is provided, underneath the central portion of the second compartment 143, with an apertured top panel 167, through which the cooling airflow can escape the bottom airflow passage 165 and enter the second compartment 143.

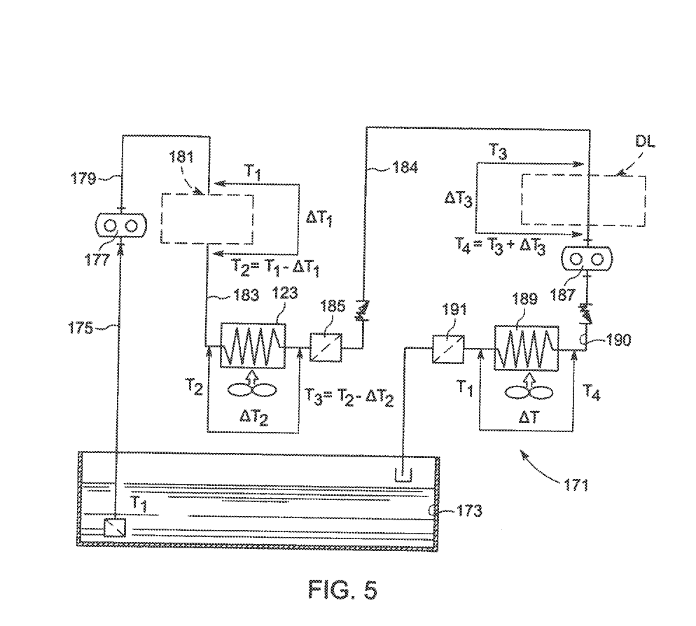

The secondary lubricating oil cooler 163 forms part of a lubricating oil circuit, which is schematically represented in FIG. 5. In this figure, the lubricating oil circuit is labelled 171 as a whole. The secondary lubricating oil cooler is again labelled 163.

In the exemplary embodiment illustrated in FIG. 5, the lubricating oil circuit 171 further comprises a lubricating oil tank 173, wherefrom lubricating oil is drawn along a pipe 175 by a lubricating oil pump 177. The lubricating oil pumped by the lubricating oil pump 177 is delivered through a pipe 179 to a variable-geometry hydraulic system globally designated 181. As known to those skilled in the art, at least a fraction of the lubricating oil circulating in pipe 179 can be pumped into the variable-geometry hydraulic system 181 and is returned in the main lubricating oil circuit through a pipe 183. The latter is in fluid communication with the secondary lubricating oil cooler 163. The cooled lubricating oil exiting the secondary oil cooler 163 is delivered to the components of the gas turbine requiring lubrication and/or cooling, such as the bearings of the shafts 115, 117. These elements are not shown in detail in the diagram of FIG. 5, but are located in the area represented by the dashed line DL in FIG. 5. A delivery filter 185 can be arranged downwards the secondary lubricating oil cooler 163, as shown in the exemplary schematic hydraulic circuit of FIG. 5

The lubricating oil exiting the bearings is collected, e.g. through a sump, by a scavenger pump 187, which delivers the collected lubricating oil through a primary lubricating oil cooler 189. A lubricating oil pipe 190 connects the scavenger pump 187 to the primary lubricating oil cooler 189. In some embodiments a scavenger filter 191 can be provided along lubricating oil piping, e.g. between the outlet side of the primary lubricating oil cooler 189 and the lubricating oil tank 173, in which the lubricating oil is collected.

The arrangement of the various components of the lubricating oil circuit can be different from the one shown in the drawings. For example, the primary lubricating oil cooler 189 can be arranged along the pipe 175, i.e. downstream of the lubricating oil tank 173.

In the diagram of FIG. 5, the temperature of the lubricating oil in various points along the circuit 171 is indicated. Ti designates the temperature of the lubricating oil in the lubricating oil tank 173. The lubricating oil is substantially at the same temperature T1 at the inlet of the variable-geometry hydraulic system 181. After flowing through the variable-geometry hydraulic system 181, the temperature of the lubricating oil has increased from T1 to T2, wherein:

T2=T1+ΔT₁°0 C.

The temperature T2 is usually higher than the admissible temperature in the bearings of the gas turbine, and therefore, heat is removed from the lubricating oil in the secondary lubricating oil cooler 163. T3 is the temperature at the exit side of the secondary lubricating oil cooler 163, wherein:

T3=T2−ΔT₂° C.

The lubricating oil enters the bearings of the gas turbine 103 at temperature T3 and, following heat removal during circulation in the bearings, the lubricating oil exiting the gas turbine 103 has a temperature T4 which is usually approximately 60° C. higher than T3, i.e.:

T4=T3+ΔT₃° C.=T3+60° C.

By flowing through the primary lubricating oil cooler 189, the lubricating oil is cooled down from temperature T4 to temperature T1, for example:

T1=T4−60° C.

In the schematic representation of FIG. 3 a lubricating oil distributing pipe 184 is shown, from which lubricating oil is delivered to the bearings of the gas turbine 103. These bearings are schematically represented at 192, 194, and 196. The lubricating oil exiting the bearings 192, 194, 196 is collected by pipes 190A, 190B, 190C and therefrom in a collector pipe, or turbine sump 190D for delivery to the scavenger pump 187.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions.

1. A gas turbine comprising:
a turbine package;
a gas turbine arranged in the turbine package;
a ventilation system for cooling the interior of the turbine package;
a lubricating oil circuit, comprising a lubricating oil pump, a lubricating oil tank, a primary lubricating oil cooler, and a secondary lubricating oil cooler arranged in the turbine package, in a position lower than a rotary shaft of the gas turbine;
wherein the ventilation system is arranged and designed such that at least part of a cooling airflow circulating in the turbine package contacts the secondary lubricating oil cooler for removing heat from the lubricating oil circulating in the secondary lubricating oil cooler.

2. The gas turbine according to claim I, wherein the lubricating oil circuit further comprises a scavenger pump arranged upstream of the primary lubricating oil cooler.

3. The gas turbine according to claim 2, wherein the scavenger pump is arranged between the primary lubricating oil cooler and bearings of the gas turbine, and the secondary lubricating oil cooler is arranged in a position lower than the bearings.

4. The gas turbine according to claim 1, comprising a combustion-air intake plenum in fluid communication with the compressor, wherein lateral airflow passages are formed between side walls of the turbine package and the combustion-air intake plenum, and at least one bottom airflow passage extends between the combustion-air intake plenum and a bottom wall of the turbine package, and wherein the secondary lubricating oil cooler is arranged across an airflow channeling, in fluid communication with the bottom airflow passage.

5. The gas turbine according to claim 1, wherein the secondary lubricating oil cooler is arranged underneath an air-pervious bottom panel of a cooling air inlet compartment.

6. The gas turbine according to claim 1, wherein the secondary lubricating oil cooler has a lubricating oil outlet in fluid communication with bearings of the gas turbine.

7. The gas turbine according to claim 1, wherein the lubricating oil circuit comprises a variable-geometry hydraulic system.

8. A method of operating a gas turbine, the method comprising:
providing a turbine package having a ventilation system for cooling the interior of the turbine package, wherein the as turbine comprises a lubricating oil circuit with at least a primary lubricating oil cooler and a secondary lubricating oil cooler the secondary lubricating oil cooler is arranged in the turbine package, in a position lower than a rotary shaft of the gas turbine;
generating a package cooling airflow;
circulating at least a portion of the package cooling airflow through the secondary lubricating oil cooler, removing heat from lubricating oil circulating in the secondary lubricating oil cooler; and
circulating the package cooling airflow through the turbine package.

9. The gas turbine according to claim 2, comprising a combustion-air intake plenum in fluid communication with the compressor, wherein lateral airflow passages are formed between side walls of the turbine package and the combustion-air intake plenum, and at least one bottom airflow passage extends between the combustion-air intake plenum and a bottom wall of the turbine package, and wherein the secondary lubricating oil cooler is arranged across an airflow channeling, in fluid communication with the bottom airflow passage.

10. The gas turbine according to claim 3, comprising a combustion-air intake plenum in fluid communication with the compressor, wherein lateral airflow passages are formed between side walls of the turbine package and the combustion-air intake plenum, and at least one bottom airflow passage extends between the combustion-air intake plenum and a bottom wall of the turbine package, and wherein the secondary lubricating oil cooler is arranged across an airflow channeling, in fluid communication with the bottom airflow passage.

11. The gas turbine according to one or more of the preceding claim 2, wherein the the secondary lubricating oil cooler is arranged underneath an air-pervious bottom panel of a cooling air inlet compartment.

12. The gas turbine according to claim 3, wherein the secondary lubricating oil cooler is arranged underneath an air-pervious bottom panel of a cooling air inlet compartment.

13. The gas turbine according to claim 4, wherein the secondary lubricating oil cooler is arranged underneath an air-pervious bottom panel of a cooling air inlet compartment.

14. The gas turbine according to claim 2, wherein the secondary lubricating oil cooler has a lubricating oil outlet in fluid communication with bearings of the gas turbine.

15. The gas turbine according to claim 3, wherein the secondary lubricating oil cooler has a lubricating oil outlet in fluid communication with the bearings of the gas turbine.

16. The gas turbine according to claim 4, wherein the secondary lubricating oil cooler has a lubricating oil outlet in fluid communication with bearings of the gas turbine.

17. The gas turbine according to claim 5, wherein the secondary lubricating oil cooler has a lubricating oil outlet in fluid communication with bearings of the gas turbine.

18. The gas turbine according to claim 2, wherein the lubricating oil circuit comprises a variable-geometry hydraulic system.

19. The gas turbine according to claim 4, wherein the lubricating oil circuit comprises a variable-geometry hydraulic system.

20. The gas turbine according to claim 5, wherein the lubricating oil circuit comprises a variable-geometry hydraulic system.
